(19) United States
(12) Patent Application Publication
(10) Pub. No.: US 2016/0377846 A1
(43) Pub. Date: Dec. 29, 2016

(54) PROJECTION LENS SYSTEM

(71) Applicant: Young Optics Inc., Hsinchu (TW)

(72) Inventors: Ching-Lung LAI, Hsinchu (TW); Yi-Hua LIN, Hsinchu (TW); Wei-Hao HUANG, Hsinchu (TW)

(21) Appl. No.: 14/750,569

(22) Filed: Jun. 25, 2015

(51) Int. Cl. G02B 13/18; G02B 27/00; G02B 9/64; G02B 13/14; G02B 13/16

(52) U.S. Cl. CPC G02B 13/18; G02B 13/143; G02B 13/16; G02B 9/64; G02B 27/0025

(57) ABSTRACT

A projection lens system includes, in order from a magnified side to a reduced side, a first lens group of positive refractive power and a second lens group of positive refractive power. The second lens group includes at least one cemented lens and at least one aspheric surface. During focusing, the first lens group remains stationary, and the second lens group is movable in a direction of an optical axis.

### BACKGROUND

Field of the Invention

The invention relates generally to an projection lens system, and more particularly to a projection lens system using short wavelength light such as blue light or ultraviolet as a light source for imaging.

Description of the Related Art

Generally, a projection lens system that uses short wavelength light as a light source is favorable for forming an image of fine patterns, since the size of the smallest spot image that can be resolved is in proportion to the wavelength. However, the projection lens system using short wavelength light is difficult to achieve a high light transmittance and may cause considerable chromatic aberrations that increase as the wavelength decreases. Therefore, it is desirable to provide a high-performance projection lens system that has an improved light transmittance and is favorable for correcting chromatic aberrations.

### BRIEF SUMMARY OF THE INVENTION

According to one aspect of the present disclosure, a projection lens system using short wavelength light for imaging includes, in order from a magnified side to a reduced side, a first lens group of positive refractive power and a second lens group of positive refractive power. The second lens group having at least one aspheric surface. During focusing, the first lens group remains stationary, and the second lens group is movable in a direction of an optical axis, wherein the condition:

T_{(λ=400)}>95%; and

C/N≧0.7 is satisfied, where T_{(λ=400)} denotes an internal transmittance measured at a wavelength of 400 nm and a thickness of 10 mm of any lens in the projection lens system, N denotes a total number of the lenses in the projection lens system, and C denotes a number of the lenses having an Abbe number of larger than 40 in the projection lens system.

According to another aspect of the present disclosure, a projection lens system using short wavelength light for imaging includes, in order from a magnified side to a reduced side, a first lens group of positive refractive power and a second lens group of positive refractive power. The second lens group having at least one aspheric surface. During focusing, the first lens group remains stationary, and the second lens group is movable in a direction of an optical axis, wherein the condition:

T_{(λ=350)}>90%; and

C/N≧0.7 is satisfied, where T_{(λ-350)} denotes an internal transmittance measured at a wavelength of 350 nm and a thickness of 10 mm of any lens in the projection lens system, N denotes a total number of the lenses in the projection lens system, and C denotes a number of the lenses having an Abbe number of larger than 40 in the projection lens system.

According to another aspect of the present disclosure, a projection lens system includes, in order from a magnified side to a reduced side, a first lens group of positive refractive power and a second lens group of positive refractive power. The second lens group includes at least one cemented lens and at least one aspheric surface. During focusing, the first lens group remains stationary, and the second lens group is movable in a direction of an optical axis.

In one embodiment, the condition: TE_{(λ=400)}>94% is satisfied, where TE_{(λ=400)} denotes an overall internal transmittance of all lenses in the projection lens system measured at a wavelength of 400 nm and a thickness of 10 mm of respective lens.

In one embodiment, the condition TE_{(λ=350)}>80% is satisfied, where TE_{(λ=350)} denotes an overall internal transmittance of all lenses in the projection lens system measured at a wavelength of 350 nm and a thickness of 10 mm of respective lens.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating an projection lens system according to an embodiment of the invention.

FIGS. 2, 3A and 3B show optical simulation results of the projection lens system shown in FIG. 1. FIG. 2 illustrates modulation transfer function (MTF) curves, FIG. 3A illustrates astigmatic field curves, and FIG. 3B illustrates percentage distortion curves.

FIG. 4 shows a schematic diagram illustrating an projection lens system according to another embodiment of the invention.

FIGS. 5, 6A and 6B show optical simulation results of the projection lens system shown in FIG. 4. FIG. 5 illustrates modulation transfer function (MTF) curves, FIG. 6A illustrates astigmatic field curves, and FIG. 6B illustrates percentage distortion curves.

FIG. 7 shows a schematic diagram illustrating an projection lens system according to another embodiment of the invention.

FIGS. 8, 9A and 9B show optical simulation results of the projection lens system shown in FIG. 7. FIG. 8 illustrates modulation transfer function (MTF) curves, FIG. 9A illustrates astigmatic field curves, and FIG. 9B illustrates percentage distortion curves.

FIG. 10 shows a schematic diagram illustrating an projection lens system according to another embodiment of the invention.

FIGS. 11, 12A and 12B show optical simulation results of the projection lens system shown in FIG. 10. FIG. 11 illustrates modulation transfer function (MTF) curves, FIG. 12A illustrates astigmatic field curves, and FIG. 12B illustrates percentage distortion curves.

FIG. 13 shows a schematic diagram illustrating an projection lens system according to another embodiment of the invention.

FIGS. 14, 15A and 15B show optical simulation results of the projection lens system shown in FIG. 13. FIG. 14 illustrates modulation transfer function (MTF) curves, FIG. 15A illustrates astigmatic field curves, and FIG. 15B illustrates percentage distortion curves.

FIG. 16 shows a schematic diagram illustrating an projection lens system according to another embodiment of the invention.

FIGS. 17, 18A and 18B show optical simulation results of the projection lens system shown in FIG. 16. FIG. 17 illustrates modulation transfer function (MTF) curves, FIG. 18A illustrates astigmatic field curves, and FIG. 18B illustrates percentage distortion curves.

FIG. 19 shows a schematic diagram illustrating an projection lens system according to another embodiment of the invention.

FIGS. 20, 21A and 21B show optical simulation results of the projection lens system shown in FIG. 19. FIG. 20 illustrates modulation transfer function (MTF) curves, FIG. 21A illustrates astigmatic field curves, and FIG. 22B illustrates percentage distortion curves.

FIG. 22 shows a schematic diagram illustrating an projection lens system according to another embodiment of the invention.

FIGS. 23, 24A and 24B show optical simulation results of the projection lens system shown in FIG. 22. FIG. 23 illustrates modulation transfer function (MTF) curves, FIG. 24A illustrates astigmatic field curves, and FIG. 24B illustrates percentage distortion curves.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

A projection lens system according to an embodiment of the invention may include a first lens group 20 of positive refractive power and a second lens group 30 of positive refractive power. During focusing, the first lens group 20 may remain stationary, and the second lens group 30 may be movable in a direction of an optical axis 12. The second lens group 30 may include at least one aspherical lens surface for correcting different kinds of optical aberrations such as spherical aberration, coma, astigmatism, field curvature, and image distortion. Besides, the second lens group 30 may include at least one cemented lens to balance chromatic aberration. A spatial light modulator 16, for example, a digital micro-mirror device (DMD), selectively reflects illumination light to produce image light, and the image light may pass through a cover plate 18, a deflection prism 22, the second lens group 30, and the first lens group 20 in succession, and then the image light is projected onto an object (not shown).

In one embodiment, each of the lenses in the projection lens system may be made of glass. When the lens is made of glass, the distribution of the refractive power of the projection lens system may be more flexible to design, and the glass material is not sensitive to temperature variations to ensure competent resolution of the projection lens system under different ambient temperatures. Further, because the second lens group 30 may include at least one aspherical lens surface, more controllable variables are obtained, and the aberration is reduced, as well as the number of required lenses can be reduced on constructing an projection lens system to reduce the total track length.

In one embodiment, the projection lens system may use short wavelength light such as blue light or ultraviolet as a light source. The optical lens system according to one embodiment may satisfy the following condition:

T_{(λ=400)}>95%; and

TE_{(λ=400)}>94%, where T_{(λ=400)} denotes an internal transmittance measured at a wavelength of 400 nm and a thickness of 10 mm of each of the lenses in the projection lens system, and TE_{(λ=400)} denotes an overall internal transmittance of all of the lenses in the projection lens system measured at a wavelength of 400 nm and a thickness of 10 mm of respective lens.

Further, the projection lens system according to one embodiment may satisfy the following condition:

T_{(λ=350)}>90%; and

TE_{(λ-350)}>80%, where T_{(λ-350)} denotes an internal transmittance measured at a wavelength of 350 nm and a thickness of 10 mm of each of the lenses in the projection lens system, and TE_{(λ-350)} denotes an overall internal transmittance of all of the lenses in the projection lens system measured at a wavelength of 350 nm and a thickness of 10 mm of respective lens.

In one embodiment, the projection lens system may satisfy the following condition:

C/N≧0.7, where N denotes a total number of the lenses in the projection lens system, and C denotes a number of the lenses having an Abbe number of larger than 40 in the projection lens system.

According to the above embodiments, the projection lens system is featured with good correction ability, high light transmittance and improved image quality.

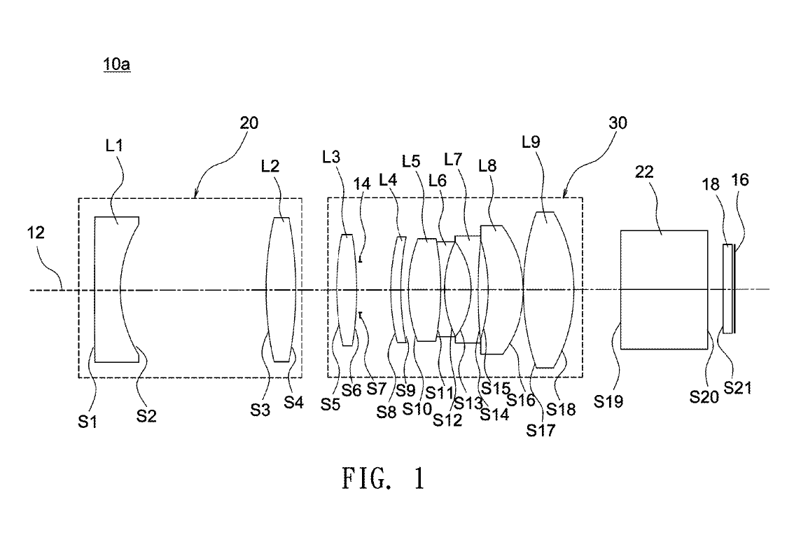

A first design example of a projection lens system 10a is described in detail below with reference to FIG. 1. As illustrated in FIG. 1, the first lens group 20 includes two lenses L1 and L2 arranged in order, along an optical axis 12, from a magnified side (on the left of FIG. 1) to a reduced side (on the right of FIG. 1). The second lens group 30 includes seven lenses L3, L4, L5, L6, L7, L8 and L9 arranged in order, along the optical axis 12, from the magnified side to the reduced side. The refractive powers of the lens L1, L2, L3, L4, L5, L6, L7, L8 and L9 are negative, positive, positive, positive, positive, negative, negative, positive and positive, respectively. The lens L9 of the second lens group 30 may have at least one aspheric surface. The lens L5 and lens L6 are integrated as one piece to form a cemented lens. An aperture stop 14 is located between the lens L3 and the lens L4. The lens L1 has a convex magnified-side surface S1 and a concave reduced-side surface S2, the lens L2 has a convex magnified-side surface S3 and a convex reduced-side surface 4, the lens L3 has a convex magnified-side surface S5 and a convex reduced-side surface 6, the lens L4 has a convex magnified-side surface S8 and a concave reduced-side surface S9, the lens L5 has a convex magnified-side surface S10, the lens L6 has a concave magnified-side surface S11 and a concave reduced-side surface S12, the lens L7 has a concave magnified-side surface S13 and a concave reduced-side surface S14, the lens L8 has a concave magnified-side surface S15 and a convex reduced-side surface S16, and the lens L9 has a convex magnified-side surface S17 and a convex reduced-side surface S18.

According to the projection lens system of the present disclosure, each of a magnified-side and a reduced-side surface of a lens has a paraxial region and a peripheral region. The paraxial region refers to the region of the surface where light rays travel close to an optical axis and the peripheral region refers to the region of the surface where light rays travel away from the optical axis. Particularly, when a lens has a convex surface, it may indicate that the surface is convex at the paraxial region; and when the lens has a concave surface, it may indicate that the surface is concave at the paraxial region.

The detailed optical data of the first example are shown in Table 1 below.

TABLE 1

| | | | | | Refrac- | |
|---|---|---|---|---|---|---|
| | radius | thickness | refractive | Abbe | tive | |
| Surface | (mm) | (mm) | index | number | power | Shape |
| S1 | 444.281 | 3.80 | 1.55 | 45.80 | L1(−) | convex |
| S2 | 17.495 | 19.90 | | | | concave |
| S3 | 37.652 | 3.62 | 1.74 | 52.60 | L2(+) | convex |
| S4 | −104.735 | 6.27 | | | | convex |
| S5 | 68.171 | 2.32 | 1.74 | 52.60 | L3(+) | convex |
| S6 | −94.965 | 0.00 | | | | convex |
| S7(stop) | INF | 4.94 | | | | |
| S8 | 31.467 | 2.03 | 1.50 | 81.60 | L4(+) | convex |
| S9 | 102.715 | 0.56 | | | | concave |
| S10 | 24.415 | 4.14 | 1.50 | 81.60 | L5(+) | convex |
| S11 | −44.318 | 0.80 | 1.63 | 35.70 | L6(−) | concave |
| S12 | 15.460 | 3.48 | | | | concave |
| S13 | −10.904 | 0.80 | 1.63 | 35.70 | L7(−) | concave |
| S14 | 79.930 | 1.46 | | | | concave |
| S15 | −29.862 | 4.98 | 1.74 | 52.60 | L8(+) | concave |
| S16 | −14.871 | 0.10 | | | | convex |
| S17 | 25.045 | 6.95 | 1.50 | 81.50 | L9(+) | convex |
| S18 | −20.498 | 6.26 | | | | convex |
| S19 | INF | 12.00 | 1.52 | 64.20 | | |
| S20 | INF | 2.00 | | | | |
| S21 | INF | 1.10 | 1.52 | 64.20 | | |

Applied to a wavelength of 405 ± 25 nm
Effective focal length of the projection lens system F = 20.7095 mm
Effective focal length of the first lens group F1 = 74.2252 mm
Effective focal length of the second lens group F2 = 32.2465 mm

Further, the aspheric surface satisfies the following equation:

$$x = \frac{{c}^{′} {y}^{2}}{1 + \sqrt{1 - ( 1 + k ) {c}^{′2} {y}^{2}}} + {Ay}^{4} + {By}^{6} + {Cy}^{8} + {Dy}^{10} + {Ey}^{12} + {Fy}^{14} + {Gy}^{16} … ,$$

where x denotes a displacement from the vertex of a lens in the direction of the optical axis 12, c′ denotes a reciprocal of the radius of curvature at the vertex of a lens (approaching the optical axis 12), K denotes a Conic constant, y denotes a height (distance in the direction perpendicular to the optical axis 12) of the aspheric surface, and A, B, C, D, E, F and G are aspheric coefficients. The values of aspheric coefficients and Conic constant of each lens surface are listed in Table 2.

TABLE 2

Lens surface

| | S17 | S18 |
|---|---|---|
| K | 1.10071 | −2.97277 |
| A | −3.88383E−05 | −3.03061E−05 |
| B | −4.06842E−08 | −1.30204E−07 |
| C | −6.76742E−09 | −1.88563E−09 |
| D | 2.56796E−10 | 1.39610E−10 |
| E | −4.56285E−12 | −2.77246E−12 |
| F | 3.80755E−14 | 2.33529E−14 |
| G | −1.24546E−16 | −7.51743E−17 |

Table 3 lists the internal transmittance of each of the lenses L1-L9 of the projection lens system 10a and the overall internal transmittance of all of the lenses L1-L9 at different wavelengths. Table 3 clearly shows each of the lenses L1-L9 may have a light transmittance of larger than 95% at a wavelength of 380 nm or 400 nm.

TABLE 3

Internal transmittance

| | 380 nm | 400 nm |
|---|---|---|
| Lens L1 | 97.9% | 99.4% |
| Lens L2 | 97.6% | 99.0% |
| Lens L3 | 98.5% | 99.3% |
| Lens L4 | 99.9% | 99.9% |
| Lens L5 | 99.8% | 99.8% |
| Lens L6 | 98.1% | 99.6% |
| Lens L7 | 98.1% | 99.6% |
| Lens L8 | 96.8% | 98.6% |
| Lens L9 | 99.6% | 99.7% |
| Total | 86.9% | 94.8% |

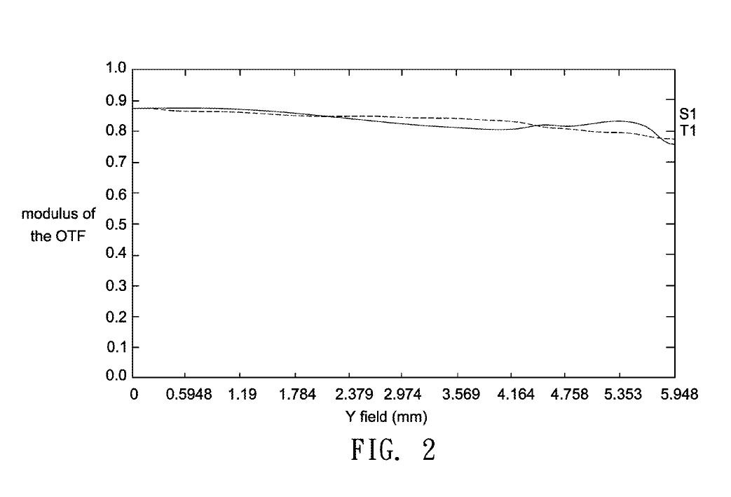

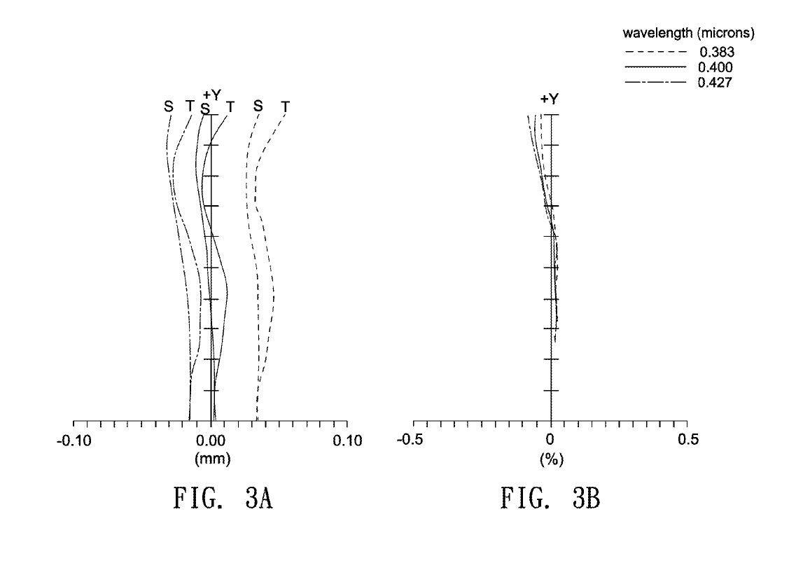

FIGS. 2, 3A and 3B show optical simulation results of the projection lens system shown in FIG. 1. FIG. 2 illustrates modulation transfer function (MTF) curves, FIG. 3A illustrates astigmatic field curves, and FIG. 3B illustrates percentage distortion curves. As shown in FIGS. 2, 3A and 3B, the MTF at a spatial frequency of 93 lp/mm is larger than 75%, and the optical distortion is smaller than 0.1%.

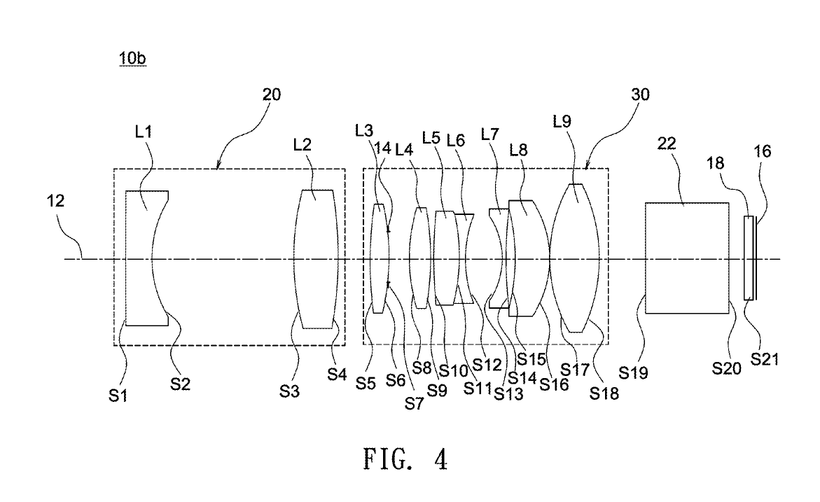

A second design example of a projection lens system 10b including nine lenses L1-L9 is described in detail below with reference to FIG. 4. The detailed optical data of the second example are shown in Table 4, and the aspheric surface data are shown in Table 5 below.

TABLE 4

| | | | | | Refrac- | |
|---|---|---|---|---|---|---|
| | radius | thickness | refractive | Abbe | tive | |
| Surface | (mm) | (mm) | index | number | power | Shape |
| S1 | 625.052 | 3.86 | 1.55 | 45.80 | L1(−) | convex |
| S2 | 17.747 | 20.17 | | | | concave |
| S3 | 37.706 | 6.02 | 1.74 | 52.60 | L2(+) | convex |
| S4 | −106.136 | 4.93 | | | | convex |
| S5 | 69.182 | 2.32 | 1.74 | 52.60 | L3(+) | convex |
| S6 | −97.034 | 0.13 | | | | convex |
| S7(stop) | INF | 3.30 | | | | |
| S8 | 31.437 | 2.12 | 1.50 | 81.60 | L4(+) | convex |
| S9 | 105.976 | 0.67 | | | | concave |
| S10 | 24.471 | 4.14 | 1.50 | 81.60 | L5(+) | convex |
| S11 | −30.954 | 0.80 | 1.63 | 35.70 | L6(−) | concave |
| S12 | 15.305 | 5.37 | | | | concave |
| S13 | −10.997 | 0.80 | 1.63 | 35.70 | L7(−) | concave |
| S14 | 77.039 | 1.12 | | | | concave |
| S15 | −30.153 | 5.10 | 1.74 | 52.60 | L8(+) | concave |
| S16 | −14.755 | 0.10 | | | | convex |
| S17 | 24.988 | 6.95 | 1.50 | 81.50 | L9(+) | convex |
| S18 | −20.407 | 6.68 | | | | convex |
| S19 | INF | 12.00 | 1.52 | 64.20 | | |
| S20 | INF | 2.00 | | | | |
| S21 | INF | 1.10 | 1.52 | 64.20 | | |

Applied to a wavelength of 470 ± 25 nm
Effective focal length of the projection lens system F = 20.9737 mm
Effective focal length of the first lens group F1 = 76.3023 mm
Effective focal length of the second lens group F2 = 32.7664 mm

TABLE 5

Lens surface

| | S17 | S18 |
|---|---|---|
| K | 1.71870 | −3.21861 |
| A | −3.25263E−05 | −2.71939E−05 |
| B | −1.35733E−08 | −2.25391E−08 |
| C | −5.89587E−09 | −1.52209E−09 |
| D | 2.66412E−10 | 1.40539E−10 |
| E | −4.58516E−12 | −2.71012E−12 |
| F | 3.78333E−14 | 2.40216E−14 |
| G | −1.18483E−16 | −7.75110E−17 |

Table 6 lists the internal transmittance of each of the lenses L1-L9 of the projection lens system 10b and the overall internal transmittance of all of the lenses L1-L9 at different wavelengths. Table 6 clearly shows each of the lenses L1-L9 may have an internal transmittance of larger than 95% at a wavelength of 400 nm or 460 nm.

TABLE 6

Internal transmittance

| | 400 nm | 460 nm |
|---|---|---|
| Lens L1 | 99.4% | 99.8% |
| Lens L2 | 98.3% | 99.5% |
| Lens L3 | 99.3% | 99.8% |
| Lens L4 | 99.9% | 99.9% |
| Lens L5 | 99.8% | 99.8% |
| Lens L6 | 99.6% | 99.9% |
| Lens L7 | 99.6% | 99.9% |
| Lens L8 | 98.5% | 99.5% |
| Lens L9 | 99.7% | 99.7% |
| Total | 94.1% | 97.9% |

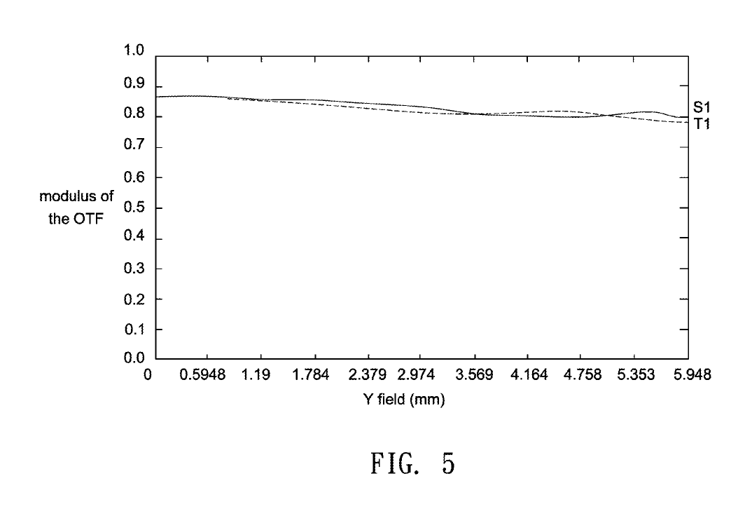

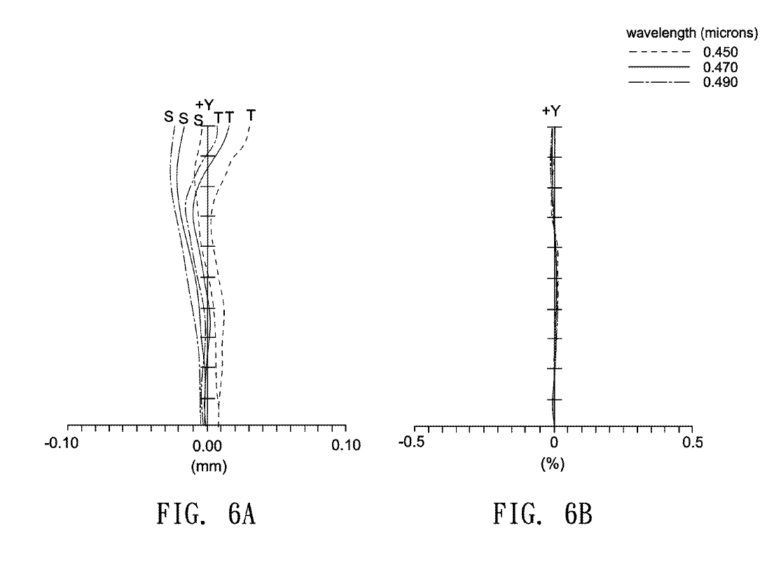

FIGS. 5, 6A and 6B show optical simulation results of the projection lens system shown in FIG. 4. FIG. 5 illustrates modulation transfer function (MTF) curves, FIG. 6A illustrates astigmatic field curves, and FIG. 6B illustrates percentage distortion curves. As shown in FIGS. 5, 6A and 6B, the MTF at a spatial frequency of 93 lp/mm is larger than 75%, and the optical distortion is smaller than 0.1%.

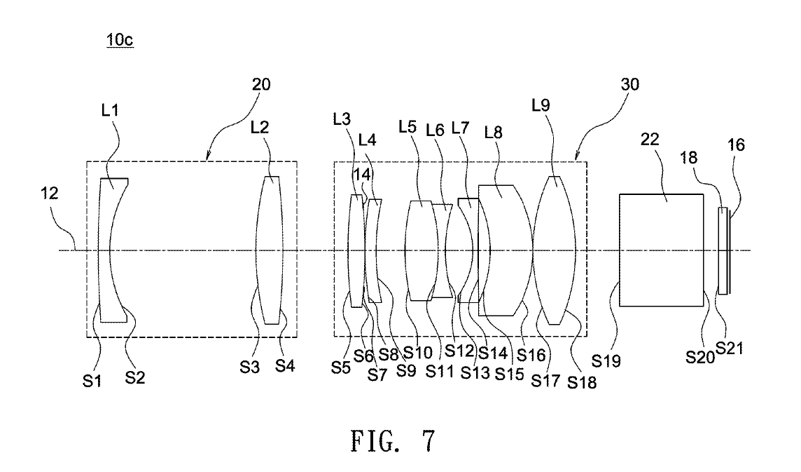

A third design example of a projection lens system 10c including nine lenses L1-L9 is described in detail below with reference to FIG. 7. The detailed optical data of the second example are shown in Table 7, and the aspheric surface data are shown in Table 8 below.

TABLE 7

| | | | | | Refrac- | |
|---|---|---|---|---|---|---|
| | radius | thickness | refractive | Abbe | tive | |
| Surface | (mm) | (mm) | index | number | power | Shape |
| S1 | 340.136 | 1.00 | 1.55 | 45.80 | L1(−) | convex |
| S2 | 17.758 | 20.48 | | | | concave |
| S3 | 38.668 | 3.90 | 1.74 | 52.60 | L2(+) | convex |
| S4 | −109.511 | 9.32 | | | | convex |
| S5 | 55.037 | 2.37 | 1.74 | 52.60 | L3(+) | convex |
| S6 | −127.435 | 0.00 | | | | convex |
| S7(stop) | INF | 0.10 | | | | |
| S8 | 45.900 | 2.04 | 1.50 | 81.60 | L4(+) | convex |
| S9 | 571.706 | 3.58 | | | | concave |
| S10 | 26.836 | 4.67 | 1.50 | 81.60 | L5(+) | convex |
| S11 | −24.052 | 0.80 | 1.63 | 35.70 | L6(−) | concave |
| S12 | 16.821 | 3.97 | | | | concave |
| S13 | −11.516 | 0.80 | 1.63 | 35.70 | L7(−) | concave |
| S14 | 278.385 | 1.26 | | | | concave |
| S15 | −27.830 | 6.64 | 1.74 | 52.60 | L8(+) | concave |
| S16 | −15.936 | 0.10 | | | | convex |
| S17 | 23.947 | 5.84 | 1.50 | 81.60 | L9(+) | convex |
| S18 | −24.778 | 6.06 | | | | convex |
| S19 | INF | 12.00 | 1.52 | 64.20 | | |
| S20 | INF | 2.00 | | | | |
| S21 | INF | 1.10 | 1.52 | 64.20 | | |

Applied to a wavelength of 405 ± 25 nm
Effective focal length of the projection lens system F = 21.3556 mm
Effective focal length of the first lens group F1 = 76.9390 mm
Effective focal length of the second lens group F2 = 32.5259 mm

TABLE 8

| Radius | S17 | S18 |
|---|---|---|
| K | 0.62489 | −4.35368 |
| A | −3.28231E−05 | −2.29932E−05 |
| B | −2.68419E−08 | −1.16262E−07 |
| C | −7.57941E−09 | −2.73603E−09 |
| D | 2.60161E−10 | 1.55837E−10 |
| E | −4.36140E−12 | −2.95646E−12 |
| F | 3.44500E−14 | 2.40146E−14 |
| G | −1.09708E−16 | −7.68070E−17 |

Table 9 lists the internal transmittance of each of the lenses L1-L9 of the projection lens system 10c and the overall internal transmittance of all of the lenses L1-L9 at different wavelengths. Table 9 clearly shows each of the lenses L1-L9 may have an internal transmittance of larger than 95% at a wavelength of 380 nm or 400 nm.

TABLE 9

Internal transmittance

| | 380 nm | 400 nm |
|---|---|---|
| Lens L1 | 99.4% | 99.8% |
| Lens L2 | 97.5% | 98.9% |
| Lens L3 | 98.5% | 99.3% |
| Lens L4 | 99.9% | 99.9% |
| Lens L5 | 99.7% | 99.8% |
| Lens L6 | 98.1% | 99.6% |
| Lens L7 | 98.1% | 99.6% |
| Lens L8 | 95.7% | 98.1% |
| Lens L9 | 99.6% | 99.7% |
| Total | 87.2% | 94.7% |

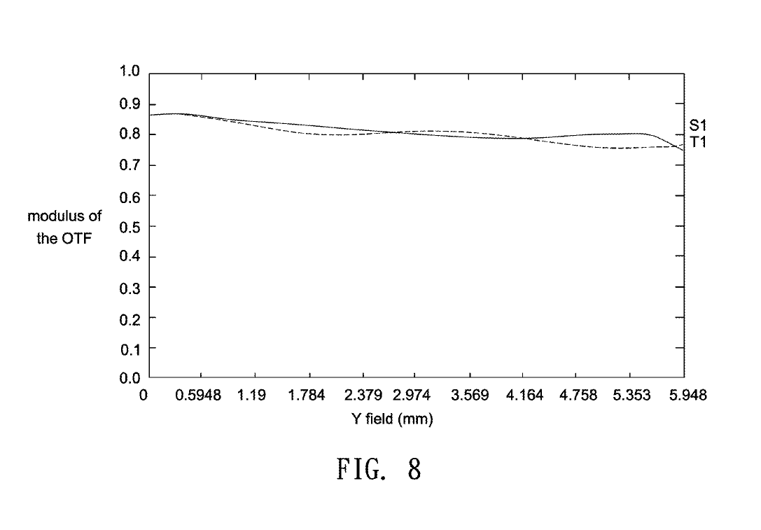

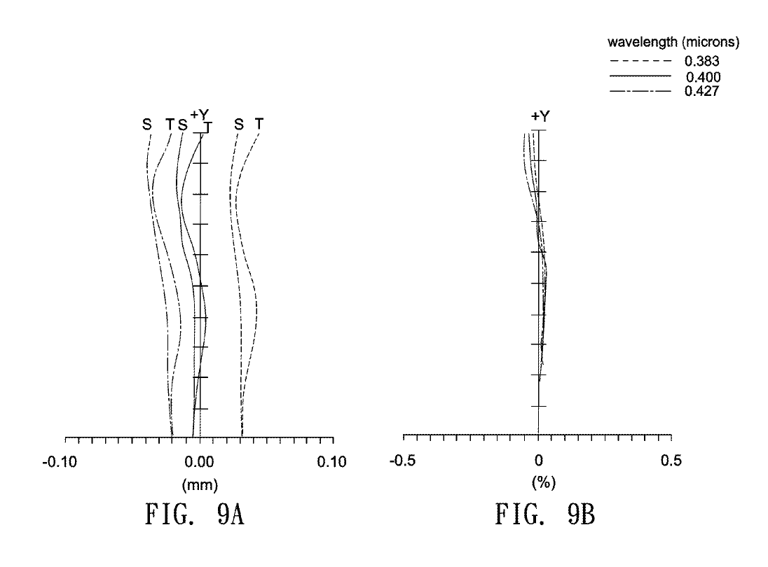

FIGS. 8, 9A and 9B show optical simulation results of the projection lens system shown in FIG. 7. FIG. 8 illustrates modulation transfer function (MTF) curves, FIG. 9A illustrates astigmatic field curves, and FIG. 9B illustrates percentage distortion curves. As shown in FIGS. 8, 9A and 9B, the MTF at a spatial frequency of 93 lp/mm is larger than 75%, and the optical distortion is smaller than 0.1%.

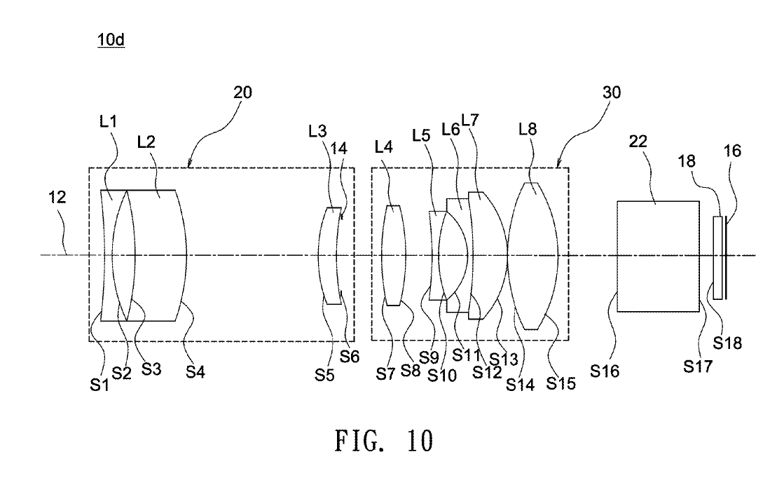

A fourth design example of the projection lens system 10d including eight lenses L1-L8 is described in detail below with reference to FIG. 10. The detailed optical data of the first example are shown in Table 10, and the aspheric surface data are shown in Table 11 below.

TABLE 10

| | | | | | Refrac- | |
|---|---|---|---|---|---|---|
| | radius | thickness | refractive | Abbe | tive | |
| Surface | (mm) | (mm) | index | number | power | Shape |
| S1 | −145.942 | 1.18 | 1.49 | 70.20 | L1(−) | concave |
| S2 | 19.502 | 3.53 | | | | concave |
| S3 | −37.008 | 7.44 | 1.75 | 52.30 | L2(+) | concave |
| S4 | −26.602 | 19.07 | | | | convex |
| S5 | 20.939 | 2.95 | 1.50 | 81.50 | L3(+) | convex |
| S6(stop) | 109.747 | 6.02 | | | | concave |
| S7 | 31.202 | 3.30 | 1.70 | 55.50 | L4(+) | convex |
| S8 | −49.052 | 4.32 | | | | convex |
| S9 | −26.587 | 0.82 | 1.62 | 36.30 | L5(−) | concave |
| S10 | 21.384 | 4.15 | | | | concave |
| S11 | −8.911 | 0.80 | 1.62 | 36.30 | L6(−) | concave |
| S12 | −60.360 | 4.87 | 1.75 | 52.30 | L7(+) | concave |
| S13 | −13.916 | 0.37 | | | | convex |
| S14 | 23.758 | 6.79 | 1.50 | 81.50 | L8(+) | convex |
| S15 | −20.132 | 8.77 | | | | convex |
| S16 | INF | 12.00 | 1.52 | 64.20 | | |
| S17 | INF | 2.00 | | | | |
| S18 | INF | 1.10 | 1.52 | 64.20 | | |

Applied to a wavelength of 405 ± 25 nm
Effective focal length of the projection lens system F = 18.0912 mm
Effective focal length of the first lens group F1 = 56.5119 mm
Effective focal length of the second lens group F2 = 27.1366 mm

TABLE 11

| Radius | S14 | S15 |
|---|---|---|
| K | 0.00000 | 0.00000 |
| A | −2.82044E−05 | 3.63169E−05 |
| B | 2.45762E−08 | −2.69222E−08 |
| C | −1.00424E−10 | 2.65369E−10 |
| D | −4.13447E−13 | −1.10686E−12 |
| E | 0.00000E+00 | 0.00000E+00 |
| F | 0.00000E+00 | 0.00000E+00 |
| G | 0.00000E+00 | 0.00000E+00 |

Table 12 lists the internal transmittance of each of the lenses L1-L8 of the projection lens system 10d and the overall internal transmittance of all of the lenses L1-L8 at different wavelengths. Table 12 clearly shows each of the lenses L1-L8 may have an internal transmittance of larger than 95% at a wavelength of 380 nm or 400 nm.

TABLE 12

Internal transmittance

| | 380 nm | 400 nm |
|---|---|---|
| Lens L1 | 100.0% | 100.0% |
| Lens L2 | 96.7% | 98.5% |
| Lens L3 | 99.8% | 99.9% |
| Lens L4 | 98.6% | 99.4% |
| Lens L5 | 100.0% | 100.0% |
| Lens L6 | 100.0% | 100.0% |
| Lens L7 | 97.9% | 99.0% |
| Lens L8 | 99.6% | 99.7% |
| Total | 92.7% | 96.4% |

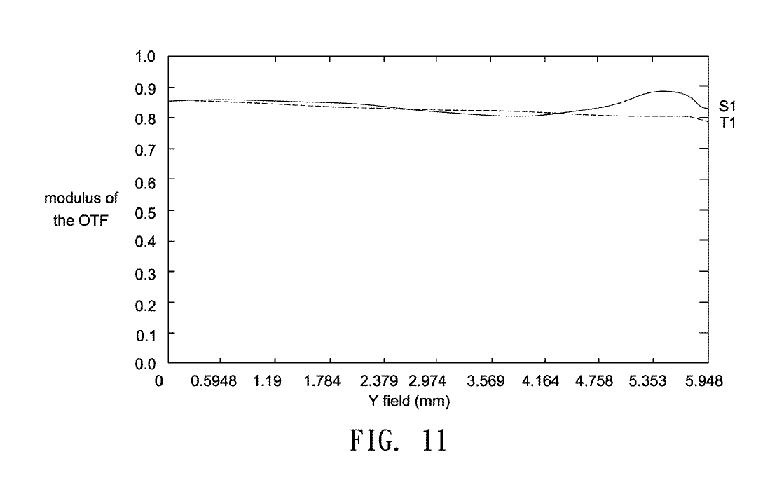

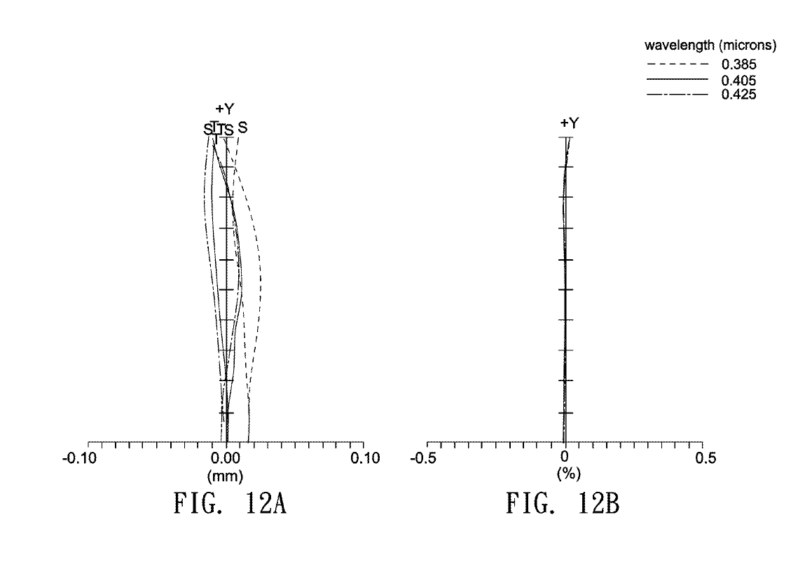

FIGS. 11, 12A and 12B show optical simulation results of the projection lens system shown in FIG. 10. FIG. 11 illustrates modulation transfer function (MTF) curves, FIG. 12A illustrates astigmatic field curves, and FIG. 12B illustrates percentage distortion curves. As shown in FIGS. 11, 12A and 12B, the MTF at a spatial frequency of 93 lp/mm is larger than 75%, and the optical distortion is smaller than 0.1%.

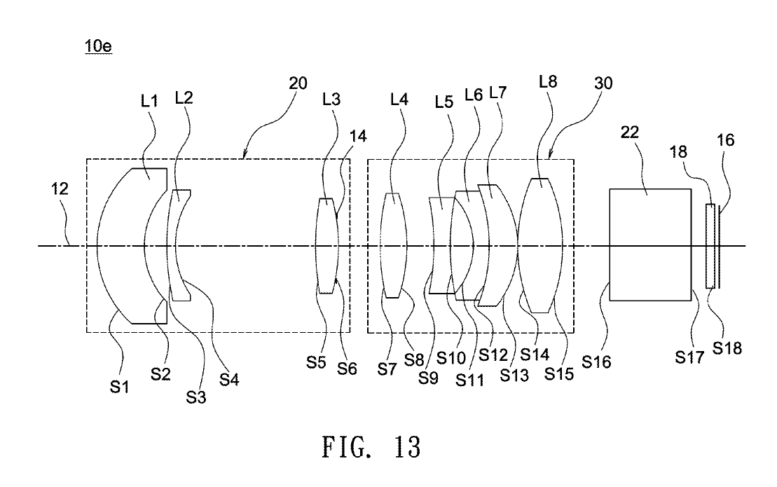

A fifth design example of the projection lens system 10e including eight lenses L1-L8 is described in detail below with reference to FIG. 13. The detailed optical data of the first example are shown in Table 13, and the aspheric surface data are shown in Table 14 below.

TABLE 13

| | | | | | Refrac- | |
|---|---|---|---|---|---|---|
| | radius | thickness | refractive | Abbe | tive | |
| Surface | (mm) | (mm) | index | number | power | Shape |
| S1 | 15.363 | 6.97 | 1.75 | 52.30 | L1(−) | convex |
| S2 | 11.416 | 3.41 | | | | concave |
| S3 | 53.065 | 0.80 | 1.52 | 52.40 | L2(−) | convex |
| S4 | 12.298 | 20.49 | | | | concave |
| S5 | 30.869 | 3.45 | 1.50 | 81.50 | L3(+) | convex |
| S6(stop) | −31.948 | 5.97 | | | | convex |
| S7 | 32.293 | 3.22 | 1.73 | 54.70 | L4(+) | convex |
| S8 | −72.809 | 4.17 | | | | convex |
| S9 | −70.595 | 2.67 | 1.62 | 36.30 | L5(−) | concave |
| S10 | 24.698 | 3.67 | | | | concave |
| S11 | −10.076 | 0.80 | 1.62 | 36.30 | L6(−) | concave |
| S12 | −177.804 | 5.57 | 1.60 | 65.40 | L7(+) | concave |
| S13 | −15.034 | 0.10 | | | | convex |
| S14 | 23.258 | 6.30 | 1.50 | 81.50 | L8(+) | convex |
| S15 | −21.427 | 6.80 | | | | convex |
| S16 | INF | 12.00 | 1.52 | 64.20 | | |
| S17 | INF | 2.00 | | | | |
| S18 | INF | 1.10 | 1.52 | 64.20 | | |

Applied to a wavelength of 405 ± 25 nm
Effective focal length of the projection lens system F = 19.3228 mm
Effective focal length of the first lens group F1 = 62.4585 mm
Effective focal length of the second lens group F2 = 28.2227 mm

TABLE 14

Lens surface

| | S14 | S15 |
|---|---|---|
| K | 0.00000 | 0.00000 |
| A | −3.49685E−05 | 3.34199E−05 |
| B | 4.51970E−08 | −5.43131E−08 |
| C | −5.95685E−11 | 1.05172E−09 |
| D | 1.48961E−12 | −3.29336E−12 |
| E | −1.37864E−14 | −2.98752E−14 |
| F | −1.03443E−16 | −2.25178E−16 |
| G | 4.38657E−18 | 6.95888E−18 |

Table 15 lists the internal transmittance of each of the lenses L1-L8 of the projection lens system 10e and the overall internal transmittance of all of the lenses L1-L8 at different wavelengths. Table 15 clearly shows each of the lenses L1-L8 may have a light transmittance of larger than 95% at a wavelength of 380 nm or 400 nm.

TABLE 15

Internal transmittance

| | 380 nm | 400 nm |
|---|---|---|
| Lens L1 | 96.9% | 98.6% |
| Lens L2 | 99.7% | 99.9% |
| Lens L3 | 99.8% | 99.8% |
| Lens L4 | 98.9% | 99.5% |
| Lens L5 | 99.9% | 99.9% |
| Lens L6 | 100.0% | 100.0% |
| Lens L7 | 96.4% | 98.7% |
| Lens L8 | 99.6% | 99.7% |
| Total | 91.4% | 96.2% |

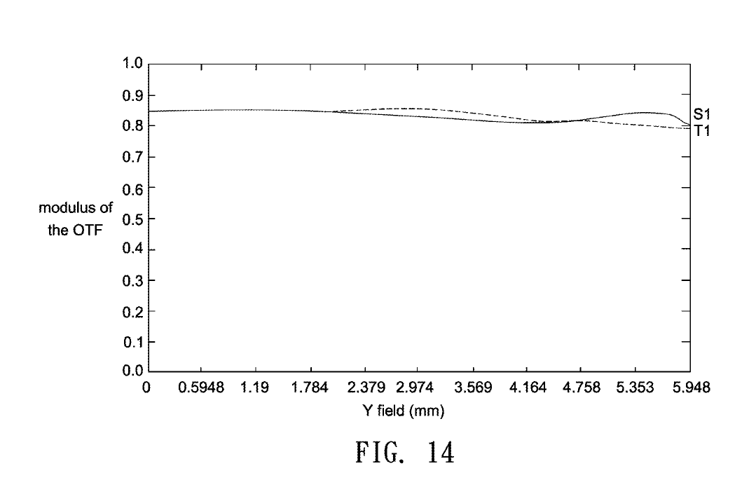

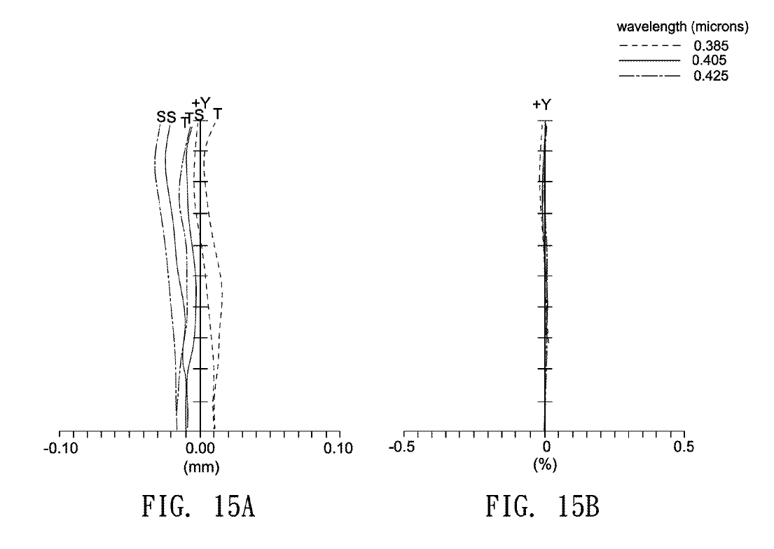

FIGS. 14, 15A and 15B show optical simulation results of the projection lens system shown in FIG. 13. FIG. 14 illustrates modulation transfer function (MTF) curves, FIG. 15A illustrates astigmatic field curves, and FIG. 15B illustrates percentage distortion curves. As shown in FIGS. 14, 15A and 15B, the MTF at a spatial frequency of 93 lp/mm is larger than 75%, and the optical distortion is smaller than 0.1%.

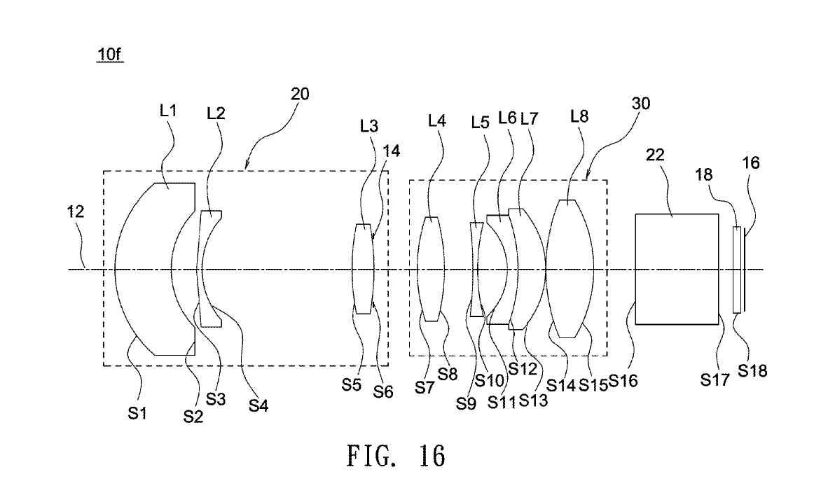

A sixth design example of the projection lens system 10f including eight lenses L1-L8 is described in detail below with reference to FIG. 16. The detailed optical data of the first example are shown in Table 16, and the aspheric surface data are shown in Table 17 below.

TABLE 16

| | | | | | Refrac- | |
|---|---|---|---|---|---|---|
| | radius | thickness | refractive | Abbe | tive | |
| Surface | (mm) | (mm) | index | number | power | Shape |
| S1 | 16.076 | 7.99 | 1.75 | 52.30 | L1(−) | convex |
| S2 | 11.724 | 3.78 | | | | concave |
| S3 | 48.277 | 0.78 | 1.52 | 52.40 | L2(−) | convex |
| S4 | 11.887 | 21.39 | | | | concave |
| S5 | 30.679 | 3.39 | 1.50 | 81.50 | L3(+) | convex |
| S6(stop) | −31.664 | 6.21 | | | | convex |
| S7 | 31.206 | 3.22 | 1.73 | 54.70 | L4(+) | convex |
| S8 | −70.338 | 4.38 | | | | convex |
| S9 | −50.911 | 0.79 | 1.62 | 36.30 | L5(−) | concave |
| S10 | 24.825 | 4.10 | | | | concave |
| S11 | −9.722 | 0.85 | 1.62 | 36.30 | L6(−) | concave |
| S12 | −64.849 | 4.85 | 1.60 | 65.40 | L7(+) | concave |
| S13 | −13.881 | 0.17 | | | | convex |
| S14 | 22.656 | 6.49 | 1.50 | 81.50 | L8(+) | convex |
| S15 | −20.065 | 6.28 | | | | convex |
| S16 | INF | 12.00 | 1.52 | 64.20 | | |
| S17 | INF | 2.00 | | | | |
| S18 | INF | 1.10 | 1.52 | 64.20 | | |

Applied to a wavelength of 405 ± 25 nm
Effective focal length of the projection lens system F = 18.5414 mm
Effective focal length of the first lens group F1 = 59.4447 mm
Effective focal length of the second lens group F2 = 26.6449 mm

TABLE 17

Lens surface

| | S14 | S15 |
|---|---|---|
| K | 0.00000 | 0.00000 |
| A | −4.18757E−05 | 3.39217E−05 |
| B | 4.06563E−08 | −3.45270E−08 |
| C | −6.60500E−10 | −1.95656E−10 |
| D | −5.67731E−13 | −1.51058E−12 |
| E | 0.00000E+00 | 0.00000E+00 |
| F | 0.00000E+00 | 0.00000E+00 |
| G | 0.00000E+00 | 0.00000E+00 |

Table 18 lists the internal transmittance of each of the lenses L1-L8 of the projection lens system 10f and the overall internal transmittance of all of the lenses L1-L8 at different wavelengths. Table 18 clearly shows each of the lenses L1-L8 may have an internal transmittance of larger than 95% at a wavelength of 380 nm or 400 nm.

TABLE 18

Internal transmittance

| | 380 nm | 400 nm |
|---|---|---|
| Lens L1 | 96.5% | 98.4% |
| Lens L2 | 99.7% | 99.9% |
| Lens L3 | 99.8% | 99.8% |
| Lens L4 | 98.9% | 99.5% |
| Lens L5 | 100.0% | 100.0% |
| Lens L6 | 100.0% | 100.0% |
| Lens L7 | 96.9% | 98.9% |
| Lens L8 | 99.6% | 99.7% |
| Total | 91.5% | 96.2% |

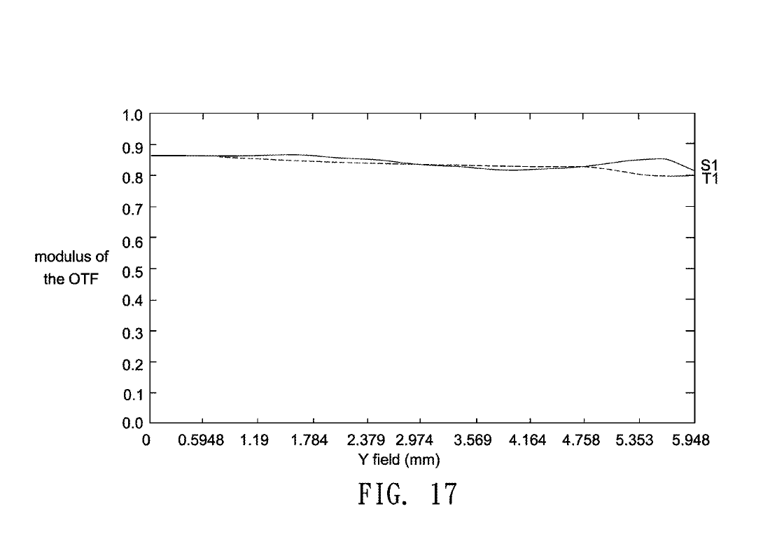

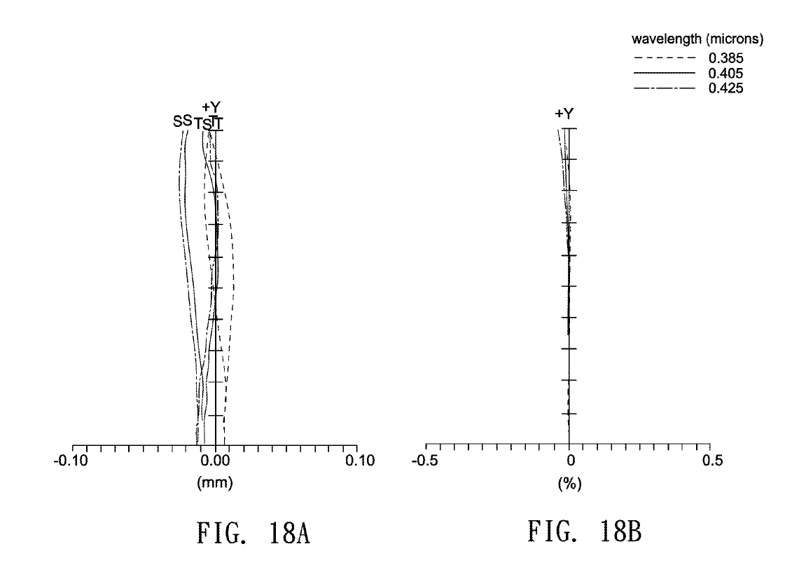

FIGS. 17, 18A and 18B show optical simulation results of the projection lens system shown in FIG. 16. FIG. 17 illustrates modulation transfer function (MTF) curves, FIG. 18A illustrates astigmatic field curves, and FIG. 18B illustrates percentage distortion curves. As shown in FIGS. 17, 18A and 18B, the MTF at a spatial frequency of 93 lp/mm is larger than 75%, and the optical distortion is smaller than 0.1%.

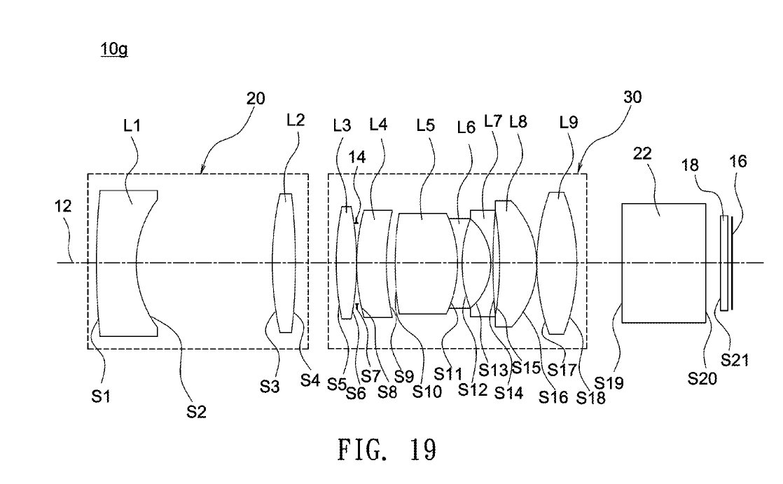

A seventh design example of a projection lens system 10g including nine lenses L1-L9 is described in detail below with reference to FIG. 19. The detailed optical data of the first example are shown in Table 19, and the aspheric surface data are shown in Table 20 below.

TABLE 19

| | | | | | Refrac- | |
|---|---|---|---|---|---|---|
| | radius | thickness | refractive | Abbe | tive | |
| Surface | (mm) | (mm) | index | number | power | Shape |
| S1 | 460.660 | 5.38 | 1.53 | 49.00 | L1(−) | convex |
| S2 | 17.286 | 18.95 | | | | concave |
| S3 | 36.212 | 3.59 | 1.65 | 58.60 | L2(+) | convex |
| S4 | −74.135 | 6.33 | | | | convex |
| S5 | 135.057 | 2.18 | 1.65 | 58.60 | L3(+) | convex |
| S6 | −67.501 | 0.00 | | | | convex |
| S7(stop) | INF | 0.23 | | | | |
| S8 | 32.635 | 4.74 | 1.65 | 58.60 | L4(+) | convex |
| S9 | 123.497 | 1.09 | | | | concave |
| S10 | 146.754 | 8.28 | 1.50 | 81.60 | L5(+) | convex |
| S11 | −18.696 | 0.65 | 1.58 | 40.80 | L6(−) | concave |
| S12 | 16.768 | 4.11 | | | | concave |
| S13 | −9.192 | 0.79 | 1.58 | 40.80 | L7(−) | concave |
| S14 | 9137.871 | 0.36 | | | | concave |
| S15 | −88.754 | 5.42 | 1.65 | 58.60 | L8(+) | concave |
| S16 | −13.303 | 0.10 | | | | convex |
| S17 | 24.462 | 5.98 | 1.50 | 81.60 | L9(+) | convex |
| S18 | −24.232 | 6.25 | | | | convex |
| S19 | INF | 12.00 | 1.52 | 64.20 | | |
| S20 | INF | 2.00 | | | | |
| S21 | INF | 1.10 | 1.52 | 64.20 | | |

Applied to a wavelength of 355 ± 25 nm
Effective focal length of the projection lens system F = 21.0242 mm
Effective focal length of the first lens group F1 = 75.2275 mm
Effective focal length of the second lens group F2 = 32.2147 mm

TABLE 20

Lens surface

| | S17 | S18 |
|---|---|---|
| K | 0.97325 | −1.11102 |
| A | −3.01353E−05 | 1.23416E−05 |
| B | −1.11844E−07 | −3.80374E−07 |
| C | −4.26331E−09 | 5.19474E−09 |
| D | 2.14074E−10 | −9.67177E−13 |
| E | −4.55735E−12 | −1.55562E−12 |
| F | 4.32461E−14 | 2.03571E−14 |
| G | −1.61214E−16 | −8.72940E−17 |

Table 21 lists the internal transmittance of each of the lenses L1-L9 of the projection lens system 10c and the overall internal transmittance of all of the lenses L1-L9 at different wavelengths. Table 9 clearly shows each of the lenses L1-L9 may have an internal transmittance of larger than 95% at a wavelength of 350 nm or 400 nm.

TABLE 21

Internal transmittance

| | 350 nm | 400 nm |
|---|---|---|
| Lens L1 | 99.7% | 99.9% |
| Lens L2 | 97.5% | 99.7% |
| Lens L3 | 98.5% | 99.8% |
| Lens L4 | 96.6% | 99.6% |
| Lens L5 | 95.6% | 99.6% |
| Lens L6 | 99.9% | 100.0% |
| Lens L7 | 99.9% | 100.0% |
| Lens L8 | 96.1% | 99.6% |
| Lens L9 | 96.8% | 99.7% |
| Total | 82.0% | 97.9% |

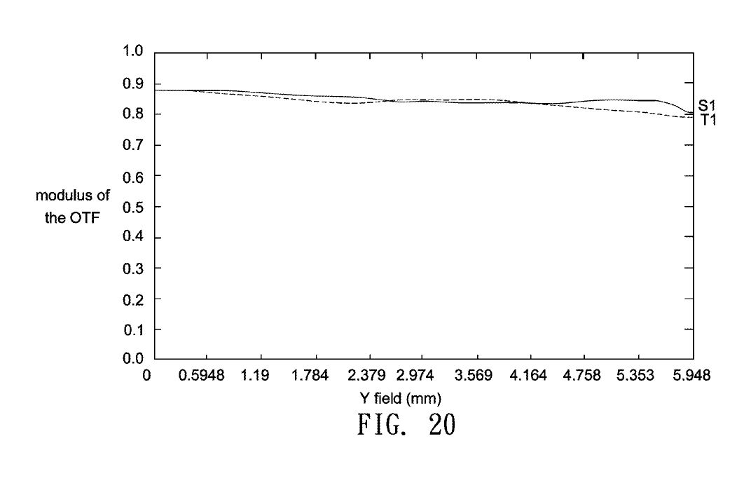

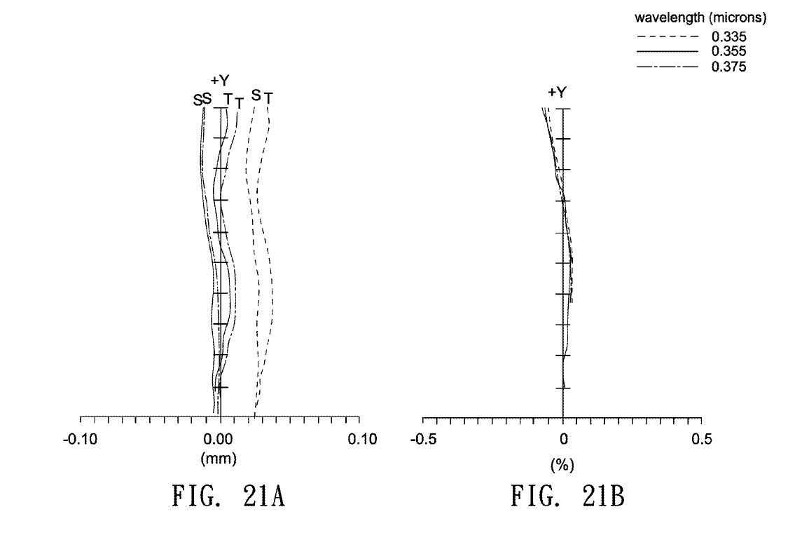

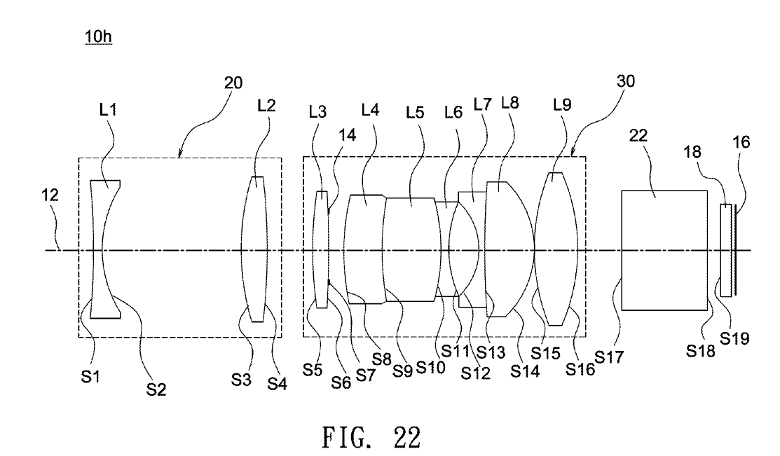

FIGS. 20, 21A and 21B show optical simulation results of the projection lens system shown in FIG. 19. FIG. 20 illustrates modulation transfer function (MTF) curves, FIG. 21A illustrates astigmatic field curves, and FIG. 22B illustrates percentage distortion curves. As shown in FIGS. 20, 21A and 21B, the MTF at a spatial frequency of 93 lp/mm is larger than 75%, and the optical distortion is smaller than 0.1%.

A eighth design example of a projection lens system 10h including nine lenses L1-L9 is described in detail below with reference to FIG. 22. The detailed optical data of the first example are shown in Table 22, and the aspheric surface data are shown in Table 23 below.

TABLE 22

| | | | | | Refrac- | |
|---|---|---|---|---|---|---|
| | radius | thickness | refractive | Abbe | tive | |
| Surface | (mm) | (mm) | index | number | power | Shape |
| S1 | −981.473 | 1.59 | 1.53 | 49.00 | L1(−) | concave |
| S2 | 18.920 | 19.31 | | | | concave |
| S3 | 36.497 | 3.51 | 1.65 | 58.60 | L2(+) | convex |
| S4 | −81.048 | 6.45 | | | | convex |
| S5 | 93.681 | 2.15 | 1.65 | 58.60 | L3(+) | convex |
| S6 | −97.564 | 0.00 | | | | convex |
| S7(stop) | INF | 2.07 | | | | |
| S8 | 32.730 | 5.72 | 1.65 | 58.60 | L4(+) | convex |
| S9 | 388.761 | 8.07 | 1.50 | 81.60 | L5(+) | convex |
| S10 | −20.119 | 0.80 | 1.58 | 40.80 | L6(−) | concave |
| S11 | 15.850 | 4.39 | | | | concave |
| S12 | −8.897 | 0.80 | 1.58 | 40.80 | L7(−) | concave |
| S13 | 397.529 | 6.76 | 1.65 | 58.60 | L8(+) | convex |
| S14 | −13.562 | 0.10 | | | | convex |
| S15 | 24.096 | 5.90 | 1.50 | 81.60 | L9(+) | convex |
| S16 | −29.486 | 6.14 | | | | convex |
| S17 | INF | 12.00 | 1.52 | 64.20 | | |
| S18 | INF | 2.00 | | | | |
| S19 | INF | 1.10 | 1.52 | 64.20 | | |

Applied to a wavelength of 355 ± 25 nm
Effective focal length of the projection lens system F = 21.5196 mm
Effective focal length of the first lens group F1 = 79.0767 mm
Effective focal length of the second lens group F2 = 32.1572 mm

TABLE 23

Lens surface

| | S15 | S16 |
|---|---|---|
| K | 1.62221 | −3.48112 |
| A | −2.56543E−05 | 1.49947E−05 |
| B | −2.52618E−07 | −4.37304E−07 |
| C | 5.36134E−10 | 9.09589E−09 |
| D | 1.34416E−10 | −5.41251E−11 |
| E | −4.22458E−12 | −1.75211E−12 |
| F | 4.58335E−14 | 2.81970E−14 |
| G | −1.81901E−16 | −1.27536E−16 |

Table 24 lists the internal transmittance of each of the lenses L1-L9 of the projection lens system 10c and the overall internal transmittance of all of the lenses L1-L9 at different wavelengths. Table 24 clearly shows each of the lenses L1-L9 may have a light transmittance of larger than 95% at a wavelength of 350 nm or 400 nm.

TABLE 24

Internal transmittance

| | 350 nm | 400 nm |
|---|---|---|
| Lens L1 | 99.9% | 100.0% |
| Lens L2 | 97.5% | 99.7% |
| Lens L3 | 98.5% | 99.8% |
| Lens L4 | 95.9% | 99.5% |
| Lens L5 | 95.7% | 99.6% |
| Lens L6 | 99.8% | 100.0% |
| Lens L7 | 99.8% | 100.0% |
| Lens L8 | 95.2% | 99.5% |
| Lens L9 | 96.9% | 99.7% |
| Total | 81.0% | 97.8% |

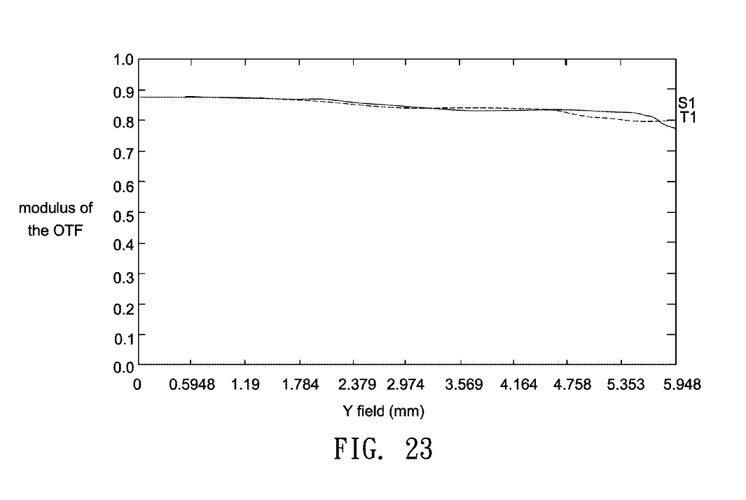

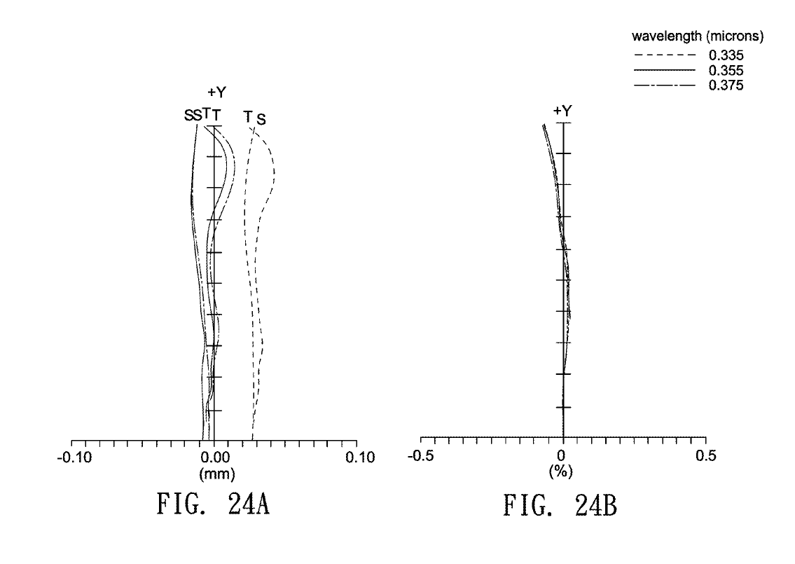

FIGS. 23, 24A and 24B show optical simulation results of the projection lens system shown in FIG. 22. FIG. 23 illustrates modulation transfer function (MTF) curves, FIG. 24A illustrates astigmatic field curves, and FIG. 24B illustrates percentage distortion curves. As shown in FIGS. 23, 24A and 24B, the MTF at a spatial frequency of 93 lp/mm is larger than 75%, and the optical distortion is smaller than 0.1%.

The simulated results are within permitted ranges specified by the standard, which indicates the projection lens system according to the above embodiments may achieve good imaging quality.

Note the parameters listed in Tables 1-24 are only for exemplified purposes but do not limit the invention. It should be appreciated that variations about the design parameters or setting may be made in the embodiments by persons skilled in the art without departing from the scope of the invention. Therefore, any projection lens system of the same structure is considered to be within the scope of the present disclosure even if it uses different data. The embodiments depicted above and the appended drawings are exemplary and are not intended to limit the scope of the present disclosure.

What is claimed is:

1. A projection lens system using short wavelength light for imaging, comprising in order from a magnified side to a reduced side:
a first lens group of positive refractive power;
a second lens group of positive refractive power, the second lens group having at least one aspheric surface and, during focusing, the first lens group remaining stationary, and the second lens group being movable in a direction of an optical axis, wherein the condition:
T_{(λ=400)}>95%; and
C/N≧0.7 is satisfied, where T_{(λ=400)} denotes an internal transmittance measured at a wavelength of 400 nm and a thickness of 10 mm of any lens in the projection lens system, N denotes a total number of the lenses in the projection lens system, and C denotes a number of the lenses having an Abbe number of larger than 40 in the projection lens system.

2. The projection lens system as claimed in claim 1, wherein the short wavelength light comprises blue light or ultraviolet.

3. The projection lens system as claimed in claim 1, wherein the second lens group comprises at least one cemented lens.

4. The projection lens system as claimed in claim 1, wherein the first lens group comprises in order from a magnified side to a reduced side:
a first lens of negative refractive power; and
a second lens of positive refractive power, and the second lens group comprises in order from a magnified side to a reduced side:
a third lens of positive refractive power;
a fourth lens of positive refractive power;
a fifth lens of positive refractive power;
a sixth lens of negative refractive power;
a seventh lens of negative refractive power;
a eighth lens of positive refractive power; and
a ninth lens of positive refractive power.

5. The projection lens system as claimed in claim 1, wherein the first lens group comprises in order from a magnified side to a reduced side:
a first lens of negative refractive power;
a second lens of positive refractive power; and
a third lens of positive refractive power, and the second lens group comprises in order from a magnified side to a reduced side:
a fourth lens of positive refractive power;
a fifth lens of negative refractive power;
a sixth lens of negative refractive power;
a seventh lens of positive refractive power; and
a eighth lens of positive refractive power.

6. The projection lens system as claimed in claim 1, wherein the first lens group comprises in order from a magnified side to a reduced side:
a first lens of negative refractive power;
a second lens of negative refractive power; and
a third lens of positive refractive power, and the second lens group comprises in order from a magnified side to a reduced side:
a fourth lens of positive refractive power;
a fifth lens of negative refractive power;
a sixth lens of negative refractive power;
a seventh lens of positive refractive power; and
a eighth lens of positive refractive power.

7. A projection lens system using short wavelength light for imaging, comprising in order from a magnified side to a reduced side:
a first lens group of positive refractive power;
a second lens group of positive refractive power, the second lens group having at least one aspheric surface and, during focusing, the first lens group remaining stationary, and the second lens group being movable in a direction of an optical axis, wherein the condition:
T_{(λ=350)}>90%; and
C/N≧0.7 is satisfied, where T_{(λ=350)} denotes an internal transmittance measured at a wavelength of 350 nm and a thickness of 10 mm of any lens in the projection lens system, N denotes a total number of the lenses in the projection lens system, and C denotes a number of the lenses having an Abbe number of larger than 40 in the projection lens system.

8. The projection lens system as claimed in claim 7, wherein the first lens group and the second lens group are adapted to be used at a wavelength of 330-400 nm.

9. The projection lens system as claimed in claim 7, wherein the second lens group comprises at least one cemented lens.

10. The projection lens system as claimed in claim 7, wherein the first lens group comprises in order from a magnified side to a reduced side:
a first lens of negative refractive power; and
a second lens of positive refractive power, and the second lens group comprises in order from a magnified side to a reduced side:
a third lens of positive refractive power;
a fourth lens of positive refractive power;
a fifth lens of positive refractive power;
a sixth lens of negative refractive power;
a seventh lens of negative refractive power;
a eighth lens of positive refractive power; and
a ninth lens of positive refractive power.

11. A projection lens system, comprising in order from a magnified side to a reduced side:
a first lens group of positive refractive power; and
a second lens group of positive refractive power comprised of at least one cemented lens, wherein the second lens group comprises at least one aspheric surface and, during focusing, the first lens group remains stationary, and the second lens group is movable in a direction of an optical axis.

12. The projection lens system as claimed in claim 11, wherein the condition:
C/N≧0.7 is satisfied, where N denotes a total number of the lenses in the projection lens system, and C denotes a number of the lenses having an Abbe number of larger than 40.

13. The projection lens system as claimed in claim 11, wherein the condition:
TE_{(λ=400)}>94% is satisfied, where TE_{(λ=400)} denotes an overall internal transmittance of all lenses in the projection lens system measured at a wavelength of 400 nm and a thickness of 10 mm of respective lens.

14. The projection lens system as claimed in claim 11, wherein the condition:
T_{(λ=400)}>95% is satisfied, where T_{(λ=400)} denotes an internal transmittance measured at a wavelength of 400 nm and a thickness of 10 mm of any lens in the projection lens system.

15. The projection lens system as claimed in claim 11, wherein the condition:
TE_{(λ=350)}>80% is satisfied, where TE_{(λ=350)} denotes an overall internal transmittance of all lenses in the projection lens system measured at a wavelength of 350 nm and a thickness of 10 mm of respective lens.

16. The projection lens system as claimed in claim 11, wherein the condition:
T_{(λ=350)}>90% is satisfied, where T_{(λ=350)} denotes an internal transmittance measured at a wavelength of 350 nm and a thickness of 10 mm of any lens in the projection lens system.

17. The projection lens system as claimed in claim 11, wherein the first lens group comprises in order from a magnified side to a reduced side:
a first lens of negative refractive power; and
a second lens of positive refractive power, and the second lens group comprises in order from a magnified side to a reduced side:
a third lens of positive refractive power;
a fourth lens of positive refractive power;
a fifth lens of positive refractive power;
a sixth lens of negative refractive power;
a seventh lens of negative refractive power;
a eighth lens of positive refractive power; and
a ninth lens of positive refractive power.

18. The projection lens system as claimed in claim 11, wherein the first lens group comprises in order from a magnified side to a reduced side:
a first lens of negative refractive power;
a second lens of positive refractive power; and
a third lens of positive refractive power, and the second lens group comprises in order from a magnified side to a reduced side:
a fourth lens of positive refractive power;
a fifth lens of negative refractive power;
a sixth lens of negative refractive power;
a seventh lens of positive refractive power; and
a eighth lens of positive refractive power.

19. The projection lens system as claimed in claim 11, wherein the first lens group comprises in order from a magnified side to a reduced side:
a first lens of negative refractive power;
a second lens of negative refractive power; and
a third lens of positive refractive power, and the second lens group comprises in order from a magnified side to a reduced side:
a fourth lens of positive refractive power;
a fifth lens of negative refractive power;
a sixth lens of negative refractive power;
a seventh lens of positive refractive power; and
a eighth lens of positive refractive power.
